(19) United States
(12) Patent Application Publication
(10) Pub. No.: US 2011/0044761 A1
(43) Pub. Date: Feb. 24, 2011

(54) Soil remediation through surface modification

(76) Inventor: Yun-Feng Chang, Houston, TX (US)

Correspondence Address: DR. YUN-FENG CHANG, 4443 STERLING WOOD WAY, HOUSTON, TX, 77059, US

(21) Appl. No.: 12/583,510

(22) Filed: Aug. 22, 2009

(51) Int. Cl. B09C 1/08

(52) U.S. Cl. 405/128.75

(57) ABSTRACT

Composition and process of surface modification of soil particles by coating to improve fertility, better moisture and nutrients retention, flooding resistance, and longer freeze-thaw-freeze cycle life.

### FIELD OF THE INVENTION

The present invention provides a composition and a process for forming a remediated soil, and more particularly to a process for forming a remediated soil by using a surface modifying agent that its presence resulting in surface coverage of the soil particles to increase soil fertility by providing better moisture and nutrient retention, facilitating microorganism growth, and enhancing percolation.

### BACKGROUND OF THE INVENTION

Despite technological advancement in crop planting, weather casting, pest control, fertilization, watering, and harvesting, meeting demand of food supply for the ever growing global population with ever decreasing of farm land under more and more frequent irregular global weather condition presents a major challenge to the world crop production community. Land overuse, depletion of nutrients, degradation of the soil structure or texture, loss of top soil, have made the challenge even more pronounced. There is a strong need to develop a fundamental remediation approach that could reverse the deterioration of the soil and to make it more robust and self-sustained for not only high productivity in a short term but in a long run.

### DESCRIPTION OF THE INVENTION

According to U.S. Pat. No. 4,459,068 by Erickson, it has been recognized that water absorbing polymers can be effective in increase water capacity and air capacity of soil matrixes comprising modification of such soil matrixes with a water-absorbing laminate by positioning in the soil a mass of said laminate having a highly cross-linked polyelectrolyte film with a layer of wicking substrates adhered to both sides of the absorbent film. Other form of absorbents, for example, finely divided particulate absorbent powder having high water absorbing capacity can be worked into the soil for soil modification. One problem associated with the laminate or film is that their integrity suffers after multiple planting-harvesting-plowing cycles. The problem with the second approach is that the adsorbent particles tend to shift position in the dry soil during mixing or working with the soil. Also, only very low concentrations of absorbent polymer can be used without causing a sealing effect in the soil. Thus, water or air cannot percolate through the soil when this sealing effect occurs. The adsorbent coated on soil particle and at the same time creates spacing for water and air to percolate solves many of these problems since it does not create sealing and it stays with the soil.

In the horticultural and lawn caring community, there is wide-spread application of biochar, or charcoal, as a soil amendment strategy. It shows an appreciable improvement in plant or grass growth and overall health. This same approach has recently been explored and expanded to crops. There are clear advantages of improved crop yield, in some cases 200-400%, coupled with reduced fertilizer use, and this technology has been demonstrated with nine different crops [see www.biochar-international.org]. The current approach of soil improvements involves addition of carbonaceous materials made by oxygen-starved burning of biomass to produce charcoal or biochar. Attention has focused on developing small robust pyrolysis units that can be used to convert local-generated biomass to biochar. These current efforts stem from archeological discoveries made of historic terra preta soils discovered in the Amazon Basin in the past 30 years. The terra preta soils provide high crop productivity and long terms robustness with very little fertilization. Research carried out on terra preta soils revealed high levels of carbonaceous materials or charcoals, or biochars. This leads to the wide spread use of charcoals. Applications of mulches, composts, and manures increase soil fertility; however, under tropical and more than mild weather conditions, the increase is short term because the added organic matter is quickly oxidized and added bases are rapidly leached (Tiessen et al., 1994). This is the result of lack of bonding between the organic matter and the soil particle surface.

We have found unexpectedly that charcoals are not created equal, some charcoals do not have any effect on crop productivity at all and while others have very high efficacy. A critical success parameter that determines whether a charcoal is effective or not is its ability to form a coating layer. over the soil surface and how much the coated phase is expanded in the presence of water. Binding between the coating layer and the underlying surface provides good retention of biochar and long term efficacy for bioactivity or soil fertility.

“Soils” refer to a number of classes of fine and grainy top deposits of earth that are used for crop productions. One type of soil is called loess. Loess can be glacial and non-glacial. Loess along the Mississippi river is classical glacial one while that in Northern China is non-glacial, resulting from erosion of sands. Loess has lower organic content than other soils, for example tropical soil. Loess particles are angular. Fertility of loess is not due to its organic content but rather other properties. Loess grains weather, they release minerals, which means that soils derived from loess are usually very rich. One theory believes that the fertility of loess soils is due largely to electron exchange capacity (EEC) and pore space (the ability of plants to absorb nutrients from soil, and air-filed space in the soil respectively). Fertility of tropical soils depends almost wholly on organic matter. Another class of rich soil is terra preta. It refers to expanses of very dark, fertile anthropogenic soils found in the Amazon Basin. It owes its name to its very high charcoal content. It is also known as “Amazonian dark earth” or “Indian black earth”. Terra preta is characterized by the presence of low-temperature charcoal in high concentrations; of high quantities of pottery sherds; of organic matter such as plant residues, animal faeces, fish and animal bones and other material; and of nutrients such as nitrogen (N), phosphorus (P), calcium (Ca), zinc (Zn), manganese (Mn) (3). It also shows high levels of microorganic activities and other specific characteristics within its particular ecosystem. It is less prone to nutrient leaching, which is a major problem in most rainforest soils. Terra preta zones are generally surrounded by terra comum, or “common soil”; these are infertile soils, mainly acrisols (3), but also ferralsols and arebisols (4).

Terra preta soils are of pre-Columbian nature and were created by humans between 450 BC and AD 950 (4,5). The soil's depth can reach 2 metres (6 feet). Thousands of years after its creation it has been reported to regenerate itself at the rate of 1 centimetre per year (6) by the local farmers and cabocolos in Brazil's Amazonian basin, and they seek it out for use and for sale as valuable compost.

“Particle size or particle size distribution (PSD)” are obtained by commonly known techniques like (1) sedigraph, for example, Micromeritics SediGraph 5000E, SediGraph 5100 based on particle sedimentation measured by x-ray, it measures particles in the range of 0.5-250 microns; (2) laser scattering, which measures light scattering by particles, particularly small particles, for example, Horiba LA910, Microtrac S3500, measuring particles in the range of 10 nm to 3000 microns; (3) acoustic and electro-acoustic techniques, for example, Matec AZR-Plus or Zeta-APS measuring particles from 10 nm to 100 microns; and Dispersion Technologies DT-1200, measuring particles in the range of 30 nm to 300 microns; (4) ultracentrifugation, in particular, disc centrifuge, for example CPS Instruments DC2400, measuring particles from 5 nm to 75 microns; (5) electroresistance counting method, an example of this is the Coulter counter, which measures the momentary changes in the conductivity of a liquid passing through an orifice that take place when individual non-conducting particles pass through. The particle count is obtained by counting pulses, and the size is dependent on the size of each pulse; (6) high sensitivity electrophoretic laser scattering technique, like Brookhaven Instruments ZetaPals and ZetaPlus, measuring particles of 10 nm to 10 microns; (7) electron microscopic imaging, scanning electron microscopy (SEM) and transmission electron microscopy (TEM); (8) optical microscopy. For a given sample, particle sizes may range from a few nanometers to a few millimeters. Often time, more than one technique is required to get the full distribution. More comprehensive dealing of particle size measurements using light scattering can reference the book, “Particle Characterization: Light Scattering Method”, by Renliang Xu, Kluwer Academic Publisher, Dordrecht, The Netherlands, 2000. More generic treaty of fine particles characterization can reference monograph “Analytical Methods in Fine Particle Technology”, by P. A. Webb and C. Orr, Micromeritics Instrument Corp., Norcross, Ga. Further reference on particle characterization and preparation can be found in the book by J-E. Otterstedt and D. A. Brandreth, “Small Particles Technology”, Plenum Press, New York, 1998; and book by A. M. Spasic and J-P. Hsu, “Finely Dispersed Particles: Micro-, Nano-, and Atto-Engineering”, Taylor & Francis, Roca Raton, 2006.

The “dₛ” particle size for purposes of this patent application and appended claims means that s percent by volume of the sediment particles have a particle diameter no greater than the dₛ value. The “median particle diameter” is the d₅₀ value for a specified plurality of sediment particles.

“Particle diameter” as used herein means the diameter of a specified spherical particle or the equivalent diameter of non-spherical particles as measured by laser scattering using for example, a Brookhaven ZetaPlus, or Microtrac Model S3500 particles size analyzer or by disc centrifuge technique using CPS Instruments DC24000.

“Surface area” herein is referred to an area measured by a BET method based on nitrogen adsorption at liquid nitrogen temperature. A high surface area material is either very small in particle size or has small pores or cavities or combination of both. Depending on pore sizes, materials having pore size smaller than 2 nm is referred to microporous materials. Materials having pores of greater than 2 nm but less than 50 nm are called mesoporous materials. For materials having pores of 50 nm or bigger, they are referred to macroporous materials. Microporous materials include natural and synthetic zeolites, for example, chabasite, SAPO-34, ZSM-5, faujasite, USY, mordenite, MCM-22. Highly recognized mesoporous materials include MCM-41, and USB-15. Microporous and mesoporous materials are widely used as catalysts or adsorbents while macroporous materials are used as filtration medium or carriers for other functionality for micro-electronic devices, sensors, or bio-applications.

“Surface modification” refers to the phenomenon where surface composition or functionality of a materials has undergone a significant change towards a desired application through physical or chemical means, for example, thermal treatment, chemical reactions, i.e., reduction, oxidation, surface capping, chemical vapor deposition (CVD), surface coating. Surface modification can results in complete reversal of surface properties, for example, a hydrophilic material can be turned into a hydrophobic materials by surface reaction where its “head” reacts with the hydrophilic surface groups while its “hydrophobic tail” sticks out of the newly formed surface making it hydrophobic.

There are a number of mechanisms a coating layer is initiated and accomplished. They include: (1) electrostatic interaction; (2) surface adsorption; (3) hydrogen bonding. FIG. 1 is the schematics of (A) electrostatic interaction; and (B) non-electrostatic interaction. Depending on composition and geological conditions, soil particles can be positively or negatively charged at or near neutral pH conditions. For soil particles that are negatively charged in aqueous suspension or slurry, addition of a positively charged particles can lead to deposition of the positively charged particles on the negatively charged soil particles due to Coulombic attraction. The coating layer now acts as spacers separating the otherwise uncoated particles. The layer thickness or spacer size can be adjusted by controlling the size of the coating particles. Often time, more than one monolayer is deposited. Furthermore, the charge density or zeta potential of the coating particles can be adjusted which can lead to different coating layer thickness and density or strength of the coating layer.

“Zeta potential” or surface charge of a particle surface acquired in a suspension or slurry is a measurement of double layer, also called Stern layer, or Stern potential. It is a property of surface as a result of (1) ionization of the surface species in a medium, (2) selective ion adsorption. Medium includes, water, polar solvent, for example, heteroatom containing compounds, oxygenates, amines, sulfides, non-polar solvent, for example, hydrocarbons. Ionics include, metal cations, K⁺, Ca²⁺, Fe²⁺, Fe³⁺, Al³⁺, cationic polymers, for example, aluminum 13-mer, Cat Floc 8108+, Superfloc C-277; inorganic anions, NO₃⁻, CO₃²⁻, SO₄²⁻, PO₄³⁻, HPO₄²⁻, Cl⁻, F⁻, ClO₄⁻, S²⁻, Mo₂O₇²⁻, SiO₄²⁻, organic anions, HCOO⁻, CH₃COO⁻, oxalic anion, citric anion, sulfonics, polyoxyethylenated fatty alcohol carboxylates, ligninsulfonates, petroleum sulfonates, N-Acyl-n-alkylataurates, sulfosuccinate esters, phosphoric and polyphosphoric acid esters, fluorinated anionics.

Zeta potential can be measured using well known techniques like electrokinetic method, acoustic and electro-acoustic method, and electrophoretic light scattering method. Widely used instruments include, Brookhaven Instruments' ZetaPals, Zeta Plus; Matec Instruments' AZR-Plus; Dispersion Technology's DT-1200; Malvern Instruments ZetaSizer and NanSizer; Beckman Coulter Instruments' Delsa Zeta Potential Analyzer; Acoustosizer from Agilent.

“Isoelectric point (IEP) or point of zero charge (PZC)” is a surface characteristics of charged particle in the presence of medium. In aqueous systems, the PZC or IEP is the pH where the surface charge is zero, or surface potential is zero, or electric mobility of the particle is zero. The PZC is the more fundamental double layer property, but cannot be determined experimentally (J-E. Otterstedt and D. A. Brandreth, “Small Particles Technology, Chapter 6, Plenum Press, New York, 1998). Instead, the IEP is used to study and characterize the stability, separation, recovery, or removal of small particles, for example, flocculation and aggregation behavior of colloidal systems. It can be determined by measuring the electric mobility as a function of pH when small monovalent cations are adsorbed on the particles. In addition to electrokinetics, acoustic and electro-acoustic spectroscopy methods, other methods, i.e., flocculation and settling measurement, adsorption measurements can also be used to determine IEP. General description and examples can be found in Chapter 3 of “Chemical Properties of Materials Surfaces”, by M. Kosmulski, Marcel Dekker, New York, 2001.

Generally speaking IEP of particles vary between 2 to 12. However, some particles do not have an IEP except at extreme acidic or basic conditions. Table 1 provides general zeta potential behavior of metal oxides. Alkali, and alkaline earth metal oxides tend to be positively charged at or near neutral pH whereas high multivalent metal oxides, dioxides and trioxides tend to be negatively charged at neutral pH.

It needs to be emphasized that surface charge or zeta potential of a particle is a surface characteristics. It is highly influenced by or dependent on the environment the particle is in, that is the medium, presence of ionics, and non-ionics, concentration of ionics and non-ionics. Due to this unique nature, zeta potential measurement and IEP determination is a highly sensitive measurement of presence of low levels of impurity, a small perturbation of process conditions. As low as a few or a few tens ppm of impurity can lead to significant change in zeta potential. The consequences can be quite dramatic. For example, an otherwise stable system, can turn into precipitation due to perturbation of process conditions leading to near IEP or passing IEP, that is charge reversal from positive to negative or the other way around. At IEP, due to lack of electrostatic repulsion, particles collide or attract to each other result in agglomeration, subsequently, leading to formation of large particles or flocs that settle or precipitate out under gravity. FIG. 2 illustrates a typical zeta potential curve and IEP.

Adsorption of anions deceases the IEP because more protons or acids are required to neutralize the negative charge of the anions adsorbed on the surface. Furthermore, multivalent anions lower IEP much more than monovalent anion. Likewise, adsorption of cations increase the IEP. Adsorbed metal cations cause the IEP to shift toward the IEP of the hydrous oxide of the metal making up the cation.

In one embodiment, the size ratio of coating particle to soil particle should be less unity, more preferably, less than 0.5, even more preferably less than 0.2. In other words, for a soil particle of 1 micron, the size of the coating particle should be smaller than 1 micron, more preferably smaller than 0.5 micron, even more preferably smaller than 0.2 micron.

To achieve fast deposition, the charge density (number of charge units per molecule or per particle) of the coating particles should be significantly greater than 0.001 meq/g, more preferably, greater than 0.002 meq/g, and even more preferably greater than 0.003 meq/g. Coating particles are selected from but not limited to carbon blacks, activated carbons, colloidal basic aluminum chloride, aluminum chlorohydrate, colloidal alumina, colloidal ceria, colloidal zirconia. Properties of selected cationic coating particles or cationic polymer modifiers are provided in Table 3.

Alternatively, the soil particle surface can be modified to acquire a charge so that the opposite charge coating particles can be deposited on the modified particles. To make the soil particles negatively charged or more negatively charged, anionic additives can be used. They can be organic or inorganic. A selected number of anionics are given in Table 3.

For selective adsorption and hydrogen bonding, surface modifiers can be selected from hydrogen bonding agents. Organic hydrogen bonding agents are listed in Table 4. The relative effectiveness of hydrogen-bonding agents is defined based on dimethoxytetraethylene glycol as 100, that is, if the amount of substance whose effectiveness is such that twice as much as required as that of the standard, then it's effectiveness is 50, likewise, if only one half the amount of the standard is needed to achieve the same effect, then this substance has an effectiveness 200. Other organic hydrogen bonding include, polymeric organic oxygenates, for instance, polyvinylalcohol (PVA), or heteroatom containing compounds, for instance, polyvinyl pyrollidone (PVP), and tertiary amines.

“Slurry or suspension” is referred to a mixture of soil and a dispersing agent, for example, water, and optionally surfactants or other surface active agents to form a suspension or slurry. The water introduced can be fresh water, or water from other industrial processes that may contain nutrients for crop growth but does not carry or does not contain harmful chemicals or components that may cause negative impact to soil fertility, i.e., pH, ion exchange capacity, composition of trace element, capacity to retain water and other nutrients.

“Solids content” of the slurry or suspension is defined as the amount of solids particles or residue left after a treatment at elevated temperature to drive off water, or any other volatiles, or combustion to burn off organics. For example, treatment of sediment sample at 550° C. for 2 hours in air resulted in a residue whose mass is 40% of the original mass, that is the solids content of this sediment sample is 40 wt %. The solids content is collection of sediment particles, and other introduced materials for example stabilizing agents or additives that are not removed at 550° C. in air.

“Dispersant or dispersion aid or surface modifier” refers to a class of components or chemicals that their addition in a small amount to a slurry or suspension can result in a significant improvement in dispersion, that is (1) increased rate of breakdown of large lumps, (2) better wetting of dry particles or powder introduced into the slurry or suspension; (3) reduced viscosity. These changes or improvements are closely related to alteration in surface properties, surface charge, charge density or zeta potential. A detail list of different types of surface modifier or surfactants can be found in “Surfactants and Interfacial Phenomena”, Chapter 1, 3^{rd} Edition, by M. J. Rosen, John Wiley & Sons, Hoboken, N.J., 2004.

Surface charge or zeta potential of a particle can be altered by a number of means. The most commonly practiced ones include water soluble ionics. Their presence or adsorption leads to major change in surface charge. Introduction of certain metal cations, i.e., K⁺, Ca²⁺, or anions, i.e., PO₄³⁻, into the treated soil may lead to fertility or long term stability, thus, are more preferred than those that are toxic or interfere with crop growth. There are three types of water soluble organic ionics: (1) cationic; (2) anionic; and (3) zwitterionic.

Zwitterionics contain both an anionic and a cationic charge under normal conditions, for example molecules containing a quaternary ammonium as the cationic group and a carboxylic group. For ionic surface modifiers the higher the charge density the more effective in surface modification. For example, according to Patton (T. C. Patton, Paint Flow and Pigment Dispersion-A Rheological Approach to Coating and Ink Technology, 2nd Edition, John Wiley & Sons, New York, pp. 1-13, pp. 270-271, 1979), efficacy of cations or anions in surface modification increased from monovalent to divalent to trivalent in a ratio of 1:64:729.

Non-ionic surface modifiers are polyelthylene oxide, polyacrylamide (PAM), partially hydrolyzed polyacrylamide (HPAM), and dextran.

Anionic surface modifiers include, carboxylate, sulfate, sulfonate and phasphate. Examples of water soluble anionic polymer are: dextran sulfates, high molecular weight ligninsulfonates prepared by a condensation reaction of formaldehyde with ligninsulfonates, and polyacrylamide. Commercially available anionic water soluble polymers include polyacrylamide, CYANAMER series from Cytec Industries Inc., West Paterson, N.J., like, A-370M/2370, P-35/P-70, P-80, P-94, F-100L & A-15; CYANAFLOC 310L, CYANAFLOC 165S.

Cationic surface modifiers: The vast majority of cationic polymers are based on the nitrogen atom carrying the cationic charge. Both amine and quaternary ammonium-based products are common. The amines only function as an effective surface modifier in the protonated state; therefore, they cannot be used at high pH. Quaternary ammonium compounds, on the other hand, are not pH sensitive. Ethoxylated amines possess properties characteristic of both cationic and non-ionics depending on chain length. Examples of water soluble cationic polymers are: polyethyleneimine, polyacrylamide-co-trimethylammonium ethyl methyl acrylate chloride (PTAMC), and poly(N-methyl-4-vinylpyridinium iodide. Commercially available materials include: Cat Floc 8108 Plus, 8102 Plus, 8103 Plus, from Nalco Chemicals, Sugar Land, Tex.; polyamines, Superfloc C500 series from Cytec Industries Inc., West Paterson, N.J., including C-521, C-567, C-572, C-573, C-577, and C-578 of different molecular weight; poly diallyl, dimethyl, ammonium chloride (poly DADMAC) C-500 series, C-587, C-591, C-592, and C-595 of varying molecular weight and charge density, and low molecular weight and high charge density C-501.

Zwitterionics: Common types of zwitterionic compounds include N-alkyl derivatives of simple amino acids, such as glycine (NH₂CH₂COOH), amino propionic acid (NH₂CH₂CH₂COOH) or polymers containing such structure segments or functional group.

In one embodiment, the coating is applied as a slurry. For better coating performance the slurry is milled to give a uniform and consistent suspension. For more efficient milling, solids content of the slurry to be milled is at least 1 wt %. It is more preferred the solids content is at least 2 wt %. It is even more preferred the solids content is at least 3 wt %, and it is most preferred that the solids content is at least 5 wt %.

Known milling techniques include but not limited to ball milling, roller milling, ultrasonication, high-shear milling, and medium milling.

In one embodiment, milling is achieved by using a high-shear mixer or mill or a medium mill or mixer or combination of both.

It is preferred that after milling particle size d₅₀ or average particle size is reduced by at least 10% from for example 20 microns to 18 microns. It is even more preferred that after milling, d₅₀ is reduced by at least 15% from for example 20 microns to 17 microns. It is most preferred that after milling d₅₀ is reduced by at least 20% from for example 20 microns to 16 microns.

It is recognized that to maximize milling throughput and efficiency a high solids content slurry is desired. However, it is also recognized that slurries having high solids content often encounter high viscosity making them difficult to homogenize, difficult to transport and even more difficult to be milled. Therefore, it is highly desired to have a process that is capable of handling high solids content slurries.

In one embodiment, transportation means that can handle high solids materials, for example, positive displacement pump is used to carry out slurry transportation from the mixing tank to the mill, for example, Moyno 1000 pump from Moyno Inc., Springfield, Ohio.

In one embodiment, a modifier is added to the slurry so that slurry viscosity can be significantly reduced. It is preferred that the surface modifier added can lead to reduction in slurry viscosity by at least 5%, that is from for example 50,000 cps to 47,500 cps, more preferred by at least 10%, that is from for example 50,000 cps to 45,000 cps, and most preferred by at least 15%, at is from for example 50,000 cps to 42,500 cps.

In one embodiment, the modifier is an ionic additive or water soluble polymer or dispersing regent selected from inorganic acids, low molecular weight organic acids, polyacids, cationic and anionic water soluble polymers.

In another embodiment, the amount of stabilizing agent added is at least 20 parts per million by weight (wt ppm). It is more preferred that the amount is at least 30 ppm. It is most preferred that the amount is at least 35 ppm.

To further demonstrate the present invention, a number of examples are provided to illustrate key aspects of the invention and its general utilities. For those skilled in the art, it would be more broadly appreciated that the present invention can be extended to other systems where surface modification is required and beneficial.

### EXAMPLES

### Example-1

A soil sample, Mississippi loess from Natchez, Miss., was in the form of big lump of 8-9 cm. Powder sample was removed from the exterior. It is more or less dry and grainy. The powder sample was mixed with distilled water using a spatula to give a mixture containing 165 mg of loess in 300 grams of water. The mixture was further homogenized by shaking in a sealed polypropylene bottle for 3 minutes. The slurry sample was used for measuring zeta potential. The slurry was not stable and settled quickly. This sample was diluted using a 1.0 mM KCl solution to give roughly 0.025 mg of solid sample per 1 ml of diluted sample for zeta potential measurement using ZetaPals from Brookhaven Instrument Co., New York. The instrument was first validated using a BI ZR3 standard provided by the instrument manufacturer. The dilute sample had initial pH of 6.4. To obtain a zeta potential curve, pH was varied by adding a diluted hydrochloric acid to bring down pH or adding a diluted potassium hydroxide to increase pH. The zeta potential curve of the Mississippi loess is given in FIG. 3. This soil sample has an IEP of 2.8. At or near neutral pH, this soil is highly negatively charged. It only becomes positively charged when pH drops to below pH of 3.

### Example-2

### Invention

A commercial charcoal, Kingsford charcoal briquettes were from made by Kingsford Product Company. The briquettes were ground to a power before mixed with distilled water. The solid concentration and mixing procedure followed that of Example-1 for making the loess sample. Zeta potential measurements were done using the same Brookhaven ZetaPals instrument according to the same procedure as that used in Example1. The zeta potential curve of the Kingsford charcoal is given in FIG. 4. It showed negative zeta potential even when pH is lowered to 2. If there is an IEP, it has to be below pH of 2. This charcoal sample is highly negatively charged at pH>3. It may become positively charged at pH<2. This behavior is similar to that of the Mississippi loess soil.

### Example-3

### Invention

A high surface area activated carbon, Black Pearls 2000 was from Cabot Corporation, Bellerica, Mass. It has a BET surface area of 1500 m²/g measured using a Micromeritics ASAP 2420 from Micromertics Instruments, Norcross, Ga. Using t-plot, we derived a micropore surface area of 1123 m²/g. A slurry containing 165 mg of carbon black in 300 grams of distilled water was made according to the same preparation procedure used in Example-1. Zeta potential measurement and sample preparation are the same as that used in Example-1. The zeta potential curve of Black Pearls 2000 is given in FIG. 5. It has an IEP of 8.7. Zeta potential of Black Pearls 2000 has a much steeper change than the Mississippi loess soil and the Kingsford charcoal. It is highly negatively charged at pH>8.7, and becomes positive at pH<8.7. At neutral pH, it is highly positively charged.

### Example-4

### Invention

A medium surface area activated carbon, Black Pearls 120 was from Cabot Corporation, Bellerica, MA. It has a BET surface area of 20 m²/g measured using a Micromeritics ASAP 2010 from Micromertics Instruments, Norcross, Ga. A slurry containing 165 mg of carbon black in 300 grams of distilled water was made according to the same preparation procedure used in Example-1. Zeta potential measurement and sample preparation are the same as that used in Example-1. The zeta potential curve of Black Pearls 2000 is given in FIG. 6. This carbon black has an IEP of 4.0. Black Pearls 120 is strikingly different from Black Pearls 2000. At or near neutral pH, Black Pearls 120 is highly negatively charged.

### Example-5

### Invention

A nano-cellulose from Sigma-Aldrich, St. Louis, Mo. suspension was prepared by dispersing it in distilled water according to the same procedure as Example-1. Procedure for sample preparation and zeta potential measurement, instrument used are the same as Example-1. The zeta potential curve of nano-cellulose (Sigma-Aldrich) is given in FIG. 7. Zeta potential is negative in the pH range investigated from 1.9 to 7. It is approaching zero charge at low pH. If there is an IEP, it is below 1.9. This materials behaves similar to that of Mississippi loess soil and the Kingsford charcoal, stays highly negatively charged at pH between 2 and higher pH.

### Example-6

### Invention

A high purity commercial alumina was received from SASOL North America, Lake Charles, La. A slurry was prepared by mixing the alumina powder with distilled water. A slurry containing 2% alumina was prepared, from which a more diluted suspension was made by adding 0.1 mM KCl solution so that the final suspension contained roughly 0.02-0.03 mg of alumina in 1 ml of the 1 mM KCl solution was made to for zeta potential measurement. Zeta potential measurement and instrument used are the same as Example 1. The zeta potential curve of alumina is given in FIG. 8. It has an IEP of 8.7. This alumina is similar to Black Pearls 2000 in terms of IEP and zeta potential behavior. The difference is that zeta potential changes are not as steep as that of Black Pearls at pH near the IEP point.

### Example-7

### Invention

An activated carbon, Norit SAE-2 was obtained from Norit, Netherlands. A slurry containing 0.2 wt % of carbon black was prepared by mixing the active carbon in the powder form with distilled water, then mixed using a mixer. This slurry was used to diluted with 1.0 mM KCl solution to give 0.03 mg of solids in 1 ml of 1.0 mM KCl. The diluted suspension was used for zeta potential measurement. Zeta potential measurement and instrument used are the same as Example 1. The zeta potential curve of alumina is given in FIG. 9. It has an IEP of 7.5. This activated carbon is close to Black Pearls 2000, but offers a slightly lower IEP. Its zeta potential does not vary as steep as that of Black Pearls 2000.

### Example-8

### Invention

A number of slurries containing both Mississippi loess and Black Pearls 2000 were prepared. Slurry-8A was prepared by adding the ground mixture of Mississippi loess and Black Pearls 2000 to distilled water. Mass ratio of the loess to Black Pearls 2000 was 10:1. The ground powder mixture was added to the distilled water to give a slurry containing 0.2 wt % solids (loess and carbon black). This slurry was diluted using 1.0 mM KCl solution to give a suspension containing 0.025 mg in 1 ml 1.0 mM KCl solution. Zeta potential measurements showed a similar behavior as that of loess, indicating that the loess surface is not covered or modified by the Black Pearls 2000 otherwise one would expect to see a significant change in IEP of the mixed system. We suspected that the amount of Black Pearls 2000 added might not be sufficient. We prepared a sample having a loess to Black Pearls 2000 mass ratio of 2:1, again there was not any appreciable change in IEP of the mixture. We also noticed that the loess particles were visibly the same color, another indication of lack of coverage by the dark black carbon black particle.

### Example-9

### Invention

Black Pearls 2000 has very small primary particles, approximately, 12 nm. PSD measurement of Mississippi loess revealed a d₅₀ of 5.26 micron. Based on the size difference one would expect that even at a much lower Black Pearls 2000 loading, the carbon black should still be enough to cover the loess particle surface if the Black Pearls 2000 is fully dispersed to its primary particles. Based on the surface charge of individually zeta potential curve of Mississippi loess and that of Black Pearls 2000, under the pH condition of the mixture (6.2-6.4) we would expect that positively charged Black Pearls 2000 particle should cover the negatively charged loess surface due to Coulombic electrostatic interaction. This unexpected result led us to explore potential solution to accomplish surface coverage and modification. We subjected the mixture to a high shear mixing using a Silverson high-shear mixture from Silverson Machinery Inc., East Longmeadow, Mass. For a slurry of 300 ml, a high-shear treatment of 2 minutes at 6500 RPM was sufficient to give a uniform slurry. Upon this high-shear treatment, the mixture turned from a slushy unstable mixture to a highly uniform and thick slurry. Now, the grainy soil particles were completely disappeared. When this milled slurry was diluted using a 1.0 mM KCl solution to give a 0.03 mg solids in 1 ml KCl solution, zeta potential behavior changed substantially from that of the un-milled. A number of samples were prepared with varying Black Pearls 2000 to Mississippi loess mass ratios. The results are given in FIG. 10. IEP of the mixture increases with decrease in ratio of loess to Black Pearls 2000. At loess to Black Pearls 2000 ratio of 2:1, the IEP is almost the same as that of pure Black Pearls 2000, indicating the surface is completely covered by Black Pearls 2000. Even at rather high loess to Black Pearls 2000 ratios, for example, 10:1, the surface IEP is more close to Black Pearls 2000 than to that of loess soil, indicating, even low level of Black Pearls 2000, can result in major modification of the loess surface. It is noticed that upon let the milled slurries sit they still settled but the settled layer is much thicker than that of the un-milled sample. It is further found that layer thickness (layer expansion) depended on loess to Black Pearls 2000 mass ratio. The results are presented in FIG. 11. Introduction of Black Pearls 2000 resulted in layer volume expansion. The higher the amount of Black Pearls 2000 in the mixture with Mississippi loess, the greater the layer expansion. At approximately 6 wt % of Black Pearls 2000 in the mixture with loess, the settled layer has expanded about 10 times of that of loess. Addition of Black Pearls 2000 to loess resulted in increase in volumetric expansion. The expansion is due to electrostatic interaction. A higher volume expansion indicates a more pronounced surface modification. A higher volume expansion suggests better water transportation at spaces between modified soil particles.

To those skilled in the art that if a charged particle or article having negative charge or negative zeta potential becomes positively charged in the presence of positively charged particles, the said negatively charged particle is now covered or encapsulated by the positively charged particles. In other words, a successful encapsulation has achieved for the former particle.

From Examples 1, one can conclude that the Mississippi loess particles are negatively charged in the entire pH range investigated, i.e., 2-12. When a positively charged Black Pearls 2000 is introduced into the Mississippi loess sample, its IEP shifted substantially higher than that of the Mississippi loess (IEP=2.8). The higher the amount of Black Pearls 2000 the further it moved away from that of the loess and closer to that of Black Pearls 2000 as shown in FIG. 10 (Example-9). It is obvious that negatively charged loess particles (Example-1) have been coated or encapsulated by the cationic Black Pearls 2000 particles.

It is further illustrated (FIG. 11 and Example-9) that coating of the Mississippi loess particles have led to volumetric expansion of the settled layer of the coated particles. From Table 2, it is concluded that coating of the soil particles by Black Pearls 2000 particles has led to appreciable increase in size of the coated particles.

It is further illustrated (Example-9) that a high-shear milling step is required to achieve significantly improved surface coverage or encapsulation of soil particles by Black Pearls 2000.

Without wishing to be bound by any particular theory, it is clear to those skilled in the art that complete surface encapsulation of one type of particle by another type of particle through surface charge interaction or modification has been accomplished.

To those skilled in the art, particles with no or near zero zeta potential can also be covered by a charged through surface interaction via chemical bonding, selective adsorption or chemisorption.

Furthermore, multiple layers can be deposited by alternating coating layer charge or degree of charge, for example, a negatively charge particle can be covered first using a positively charged particles, followed with a layer of negatively charged particle on the first coating layer.

### Tables

TABLE 1
IEP of Metal Oxides

| Metal Oxide | IEP |
|---|---|
| M₂O | >11.5 |
| MO | >8.5, <12.5 |
| M₂O₃ | >6.5, <10.5 |
| MO₂ | >0, <7.5 |
| M₂O₅ | <0.5 |
| MO₃ | <0.5 |

TABLE 2
Particle Size Distribution of Mississippi Loess and
Coated Loess by Black Pearls 2000

| Mass Ratio of Mississippi | Particle Size (micron) | | |
|---|---|---|---|
| Loess to Black Pearls 2000 | d₁₀ | d₅₀ | d₉₀ |
| 8 (loess only) | 1.91 | 5.28 | 12.85 |
| 20:01 | 3.11 | 7.63 | 16.58 |
| 10:01 | 3.62 | 9.43 | 22.30 |
| 5:01 | 4.05 | 9.72 | 21.69 |

### FIGURES

FIG. 1: Illustration of electrostatic coating of soil particles (negatively charged) by coating particle (positively charged): (A) negatively charged soil particles; (B) positively charged coating particles; (C) coating layer on soil particles. It shows that the coating particles are appreciably smaller than the underlying particles.

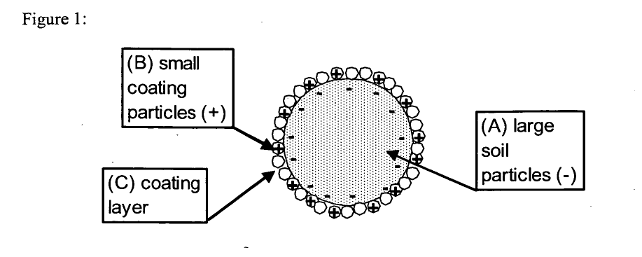

FIG. 2: Schematics of typical zeta potential curve showing curve shape, IEP: at pH below the IEP pH, zeta potential tends to be positive and its value increases with decrease in pH; at pH>IEP, zeta potential is negative, its value tends to increase as pH increase.

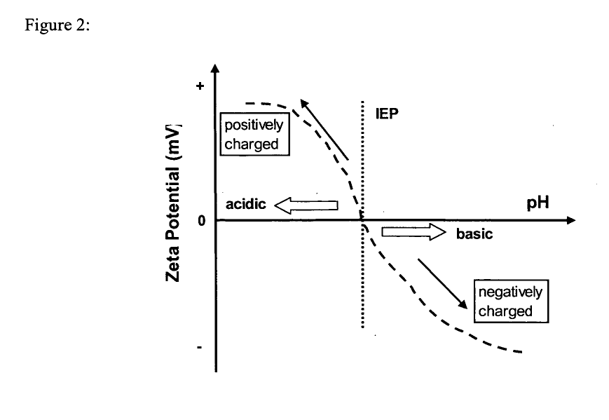

FIG. 3 Zeta potential curve of Mississippi loess soil: IEP=2.8. At or near neutral pH, this soil is highly negatively charged. It only becomes positively charged when pH drops to below pH of 3.

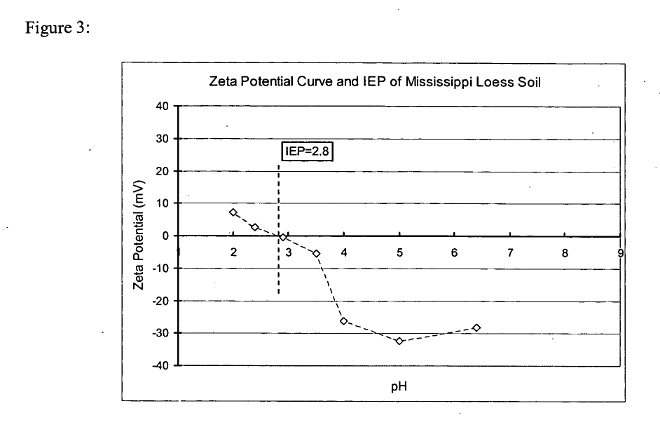

FIG. 4 Zeta potential curve of Kingsford charcoal: very low IEP if at all, <2. This charcoal sample is highly negatively charged at pH>3. It may become positively charged at pH<2. This behavior is similar to that of the Mississippi loess soil.

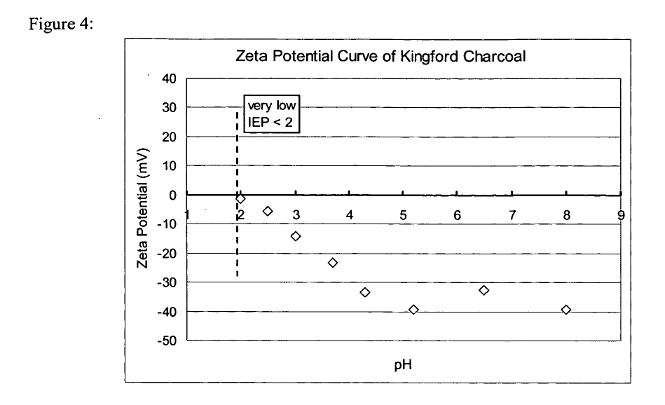

FIG. 5 Zeta potential curve of Black Pearls 2000 from Cabot: IEP=8.7. Zeta potential of Black Pearls 2000 has a much steeper change than the Mississippi loess soil and the Kingsford charcoal. It is highly negatively charged at pH>8.7, and becomes positive at pH<8.7. At neutral pH, it is highly positively charged.

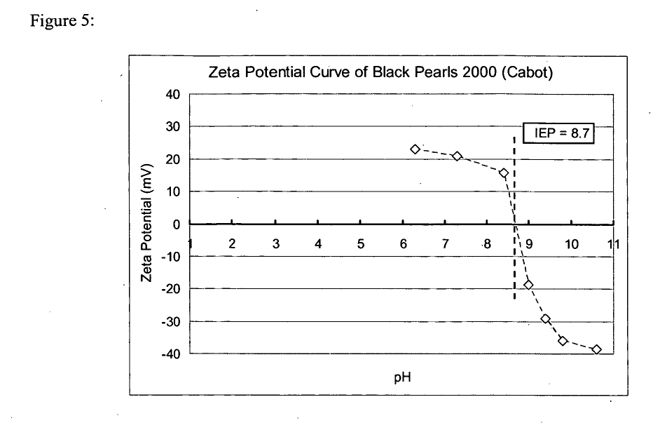

FIG. 6 Zeta potential curve of Black Pearls 120 from Cabot: IEP=4.0. This carbon black is strikingly different from Black Pearls 2000. At or near neutral pH, Black Pearls 120 is highly negatively charged.

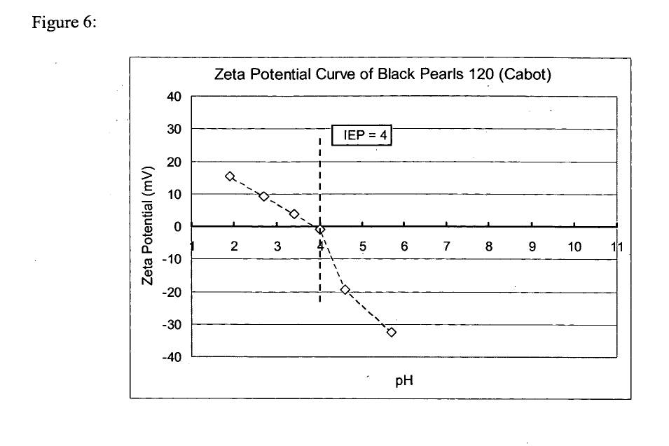

FIG. 7 Zeta potential curve of Nano Cellulose from Sigma-Aldrich: IEP<1.9. This materials behaves similar to that of Mississippi loess soil and the Kingsford charcoal, stays highly negatively charged at pH between 2 and higher pH.

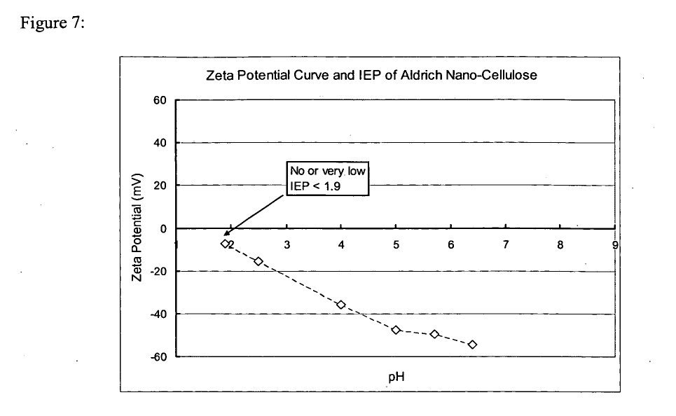

FIG. 8 Zeta potential curve of alumina from SASOL North America: IEP=8.6. This alumina is similar to Black Pearls 2000 in terms of IEP and zeta potential behavior. The difference is that zeta potential changes are not as steep as that of Black Pearls at pH near the IEP point.

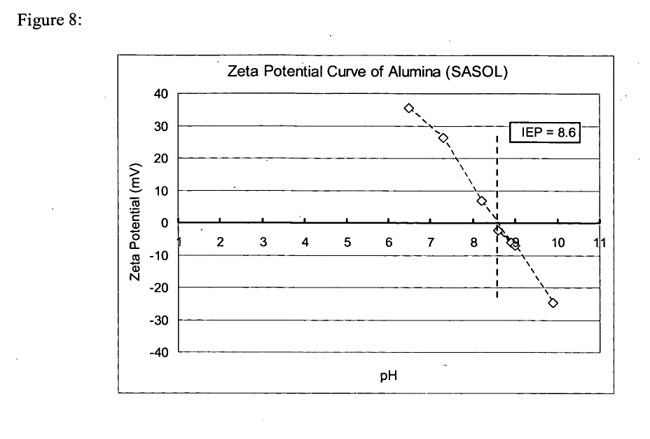

FIG. 9 Zeta potential curve of Norit SAE-2 activated carbon from Norit: IEP=7.5. This activated carbon is close to Black Pearls 2000, but offers a slightly lower IEP. Its zeta potential does not vary as steep as that of Black Pearls 2000.

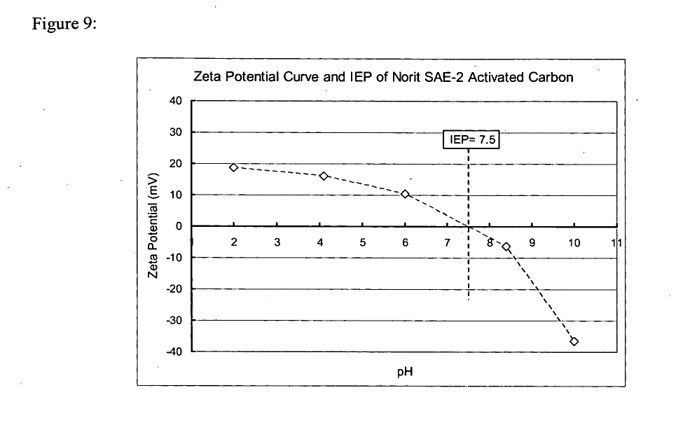

FIG. 10 Zeta potential curve of mixture of Mississippi loess and carbon black, Black Pearls 2000 from Cabot, at different loess to Black Pearls 2000 mass ratios (L/BP): L/BP=20/1: IEP=3.8; L/BP=10/1: IEP=5.7; L/BP=5/1: IEP=7.5; L/BP=2/1: IEP=8.5. IEP of the mixture increases with decrease in ratio of loess to Black Pearls 2000. At loess to Black Pearls 2000 ratio of 2:1, the IEP is almost the same as that of pure Black Pearls 2000, indicating the surface is completely covered by Black Pearls 2000. Even at rather high loess to Black Pearls 2000 ratios, for example, 10:1, the surface IEP is more close to Black Pearls 2000 than to that of loess soil, indicating, even low level of Black Pearls 2000, can result in major modification of the loess surface.

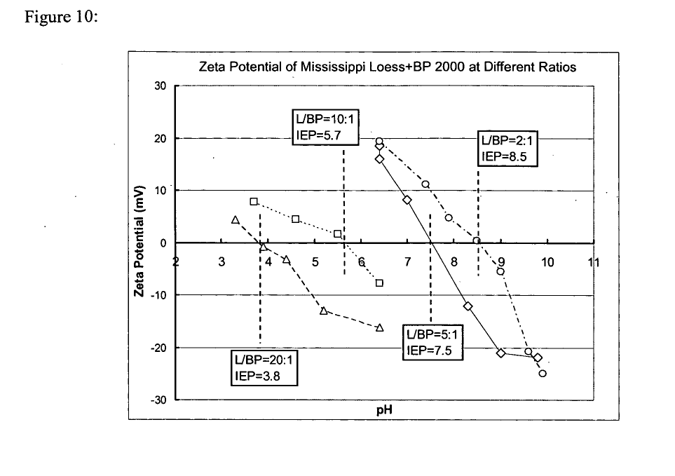

FIG. 11 Expansion of suspended layer of mixture of Mississippi loess and Black Pearls 2000. Addition of Black Pearls 2000 to loess resulted in increase in volumetric expansion. The expansion is due to electrostatic interaction. A higher volume expansion indicates a more pronounced surface modification. A higher volume expansion suggests better water transportation at spaces between modified soil particles.

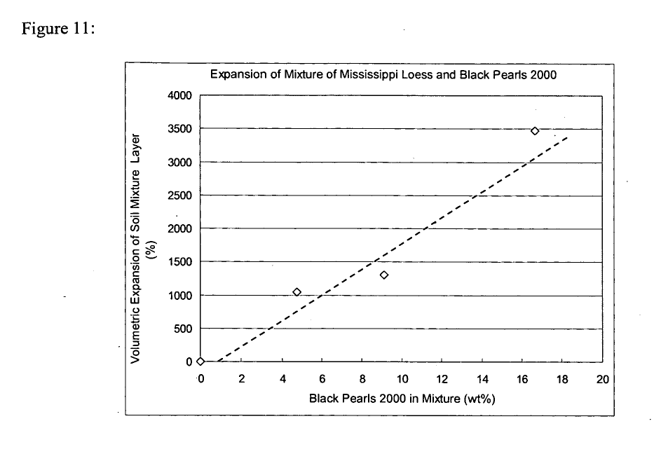

### REFERENCES

1. Erickson R.E., U.S. Pat. No. 4,459,068 (1984).
2. www.biochar-international.org.
3. Tiessen H., Cuevas E., and Chacon P., The Role of Soil Organic Matter in Sustaining Soil Fertility, Nature, 371, 587-615 (1994).
4. Novak J. M., Busscher W. J., Laird D. L., Ahmedna M., Watts D. W., and Niandow A. S., Soil Sciences, 174, 105-112 (2009).
5. Bansode R. R., “Treatment of Organic and Inorganic Pollutions in Municipal Waste Water by Agriculture By-Product Produced Granular Activated Carbon”, Thesis of Master of Science, Louisiana State University, Baton Rouge, 2002.
6. Sohi S, Lopez-Capel E., Krull E and Bol R, 2009, Biochar, Climate Change and Soil: A Review to Guide Future Research. CSIRO Land Water Science Report, May 2009.
7. R. L. Xu, “Particle Characterization: Light Scattering Method”, Kluwer Academic Publisher, Dordrecht, The Netherlands, pp. 1-24, 2000.
8. P. A. Webb and C. Orr, “Analytical Methods in Fine Particle Technology”, Micromeritics Instrument Corp., Norcross, pp. 17-28, GA.
9. J-E. Otterstedt and D. A. Brandreth, “Small Particles Technology”, Plenum Press, New York, p. 8, 1998.
10. A. M. Spasic and J-P. Hsu, “Finely Dispersed Particles: Micro-, Nano-, and Atto-Engineering”, Taylor & Francis, Roca Raton, pp. 329-340, 2006. Wiley & Sons, Hoboken, N.J., 2004.
11. M. Kosmulski, “Chemical Properties of Materials Surfaces”, Chapter 3, Marcel Dekker, New York, 2001.
12. M. J. Rosen, “Surfactants and Interfacial Phenomena”, Chapter 1, 3^{rd} Edition, John
13. T. C. Patton, “Paint Flow and Pigment Dispersion: A Rheological Approach to Coating and Ink Technology”, 2^{nd} Edition, John Wiley & Sons, New York, pp. 1-13, p. 270. 1979.

We claim:

1. A composition of particle comprising a first particle covered or encapsulated by a second particle for remediation of soil or planting composite to increase crop yields, or to enhance moisture retention, or to enhance nutrients retention, or to facilitate oxygen transportation:
(a) the first particle is selected from the group of soils or other soil-containing mixtures or composite for crop production, planting composite;
(b) the second particle is selected from the group of activated carbon, carbon black, colloids, cationic colloidal particles, metal oxides, nano-particles of oxides, clays, zeolites, molecular sieves, byproduct from a chemical process or manufacturing step.

2. The composition of claim 1, wherein its use results in increase of fertility of the remediated soil by at last 5%, more preferably by at least 10%.

3. The composition of claim 1, wherein surface modification of the first particle by the second particle has resulted in volume expansion of the mixture suspended in an aqueous medium by at least 5%, more preferably by at least 10%.

4. The composition of claim 1, wherein the first particle may carry a surface charge in an aqueous medium.

5. The composition of claim 1, wherein the second particle may carry a surface charge in an aqueous medium and wherein the surface charge measured as zeta potential of the second particle may be different from that of the first particle.

6. The composition of claim 1, wherein the second particle deposits on the surface of the first particle via electrostatic interaction.

7. The composition of claim 1, wherein the introduction of the second particle has led to a change of IEP by at least 0.1 pH unit.

8. The composition of claim 1, wherein additional layers can be deposited on top of the second particle deposits on the surface of the first particle via electrostatic interaction.

9. The composition of claim 1, wherein the first particle has a first median particle diameter of at least about 0.01 microns.

10. The composition of claim 1, wherein the second particle has a second median particle diameter of at most 50 microns.

11. The composition of claim 1, wherein the solid mass ratio of second particle to first particle is at least 0.001.

12. The composition of claim 1, wherein the solid content of mixture containing the first particle, the second particle and optionally the third particles or more particles, and a dispersing medium has a solid content of at least 0.01 wt % and at most 85 wt %.

13. A process of making a particle comprising a first particle covered or encapsulated by a second particle for improvement of fertility of remediated soil:
(a) the first particle is selected from the group of soils or other soil-containing mixtures or composite for crop production, planting composite;
(b) the second particle is selected from the group of active carbons or carbon blacks, colloids, cationic colloidal particles, metal oxides, nano-particles of oxides, clays, zeolites, molecular sieves, byproduct from a chemical process or manufacturing step.

14. The process of claim 13, wherein introduction of the second particle has led to coverage or encapsulation characterized by a shift of IEP of the first particle in the presence of second particle by at least 0.1 pH unit.

15. The process of claim 13, wherein a mixing step is used to achieve inter-particle mixing.

16. The process of claim 13, wherein a mixing step uses a mixer selected from the group of high-shear mixers, bead mills, medium mills, colloid mills.

17. The process of claim 13, wherein mixing and milling has led to improvement in surface coverage or encapsulation characterized by a shift of IEP of the first particle in the presence of second particle by at least 0.1 pH unit.

18. The process of claim 13, wherein the solids content of the mixture of the first particle, the second particle, optionally the third or additional particles, and a dispersing medium is at least 0.01 wt % and at most 85 wt %.

19. The process of applying a mixture comprising second particle, optionally the third and additional particles, and a dispersing medium following the sequence of to improve fertility of the remediated soil:
(a) the second particle is first introduced into the dispersing medium;
(b) mix or mill the above mixture
(c) apply the milled or mixed mixture containing second or optionally third particles to the first particles to modify the characteristics of the first particles
(d) apply additional surface modifier in any of the steps of (a) to (c)

20. A composition of claim 19 wherein the particle comprising a first particle and a second particle, optionally a third or additional particles:
(a) wherein the second particle has a charge density at least 0.001 meq./g;
(b) the second particle is selected from the group of activated carbons or carbon blacks, basic aluminum salts, aluminum chlorohydrates, colloidal alumina sols, Nyacol alumina sol, zirconia sols, ceria sols, polyacrylamide, polyethylene imine, polyethylene amine, cationic starch, cationic polyacrylamide or combination of thereof.
